(19) United States
(12) Patent Application Publication
(10) Pub. No.: US 2020/0299007 A1
(43) Pub. Date: Sep. 24, 2020

(54) Radioactive decay propulsion and electrical device

(71) Applicant: Ronald Lee Bennett, Henderson, NV (US)

(72) Inventor: Ronald Lee Bennett, Henderson, NV (US)

(73) Assignee: Ronald Lee Bennett

(21) Appl. No.: 16/501,273

(22) Filed: Mar. 18, 2019

(51) Int. Cl. B64G 1/40

(52) U.S. Cl. CPC B64G 1/408; G21D 7/04; B64G 1/407

(57) ABSTRACT

This embodiment relates to a lifting or flying device using the energy from the radioactive decay of radioactive elements to accelerate an object. A thin radioactive coating is spread over a large surface area that allows most of the radiated particles to escape. The force from the decay of an unobstructed side A of a flattened or curved radioactive emitting device has enough energy to push an object toward its opposite side B expelling particles or waves at relativistic speeds in its exhaust if side B is covered by a shield that prevents most of the radiation from escaping that side. Trillions of small microscopic explosions per second per gram of radioactive material has enough energy from radioactive decay from alpha, beta, or gamma rays decaying to escape on A side which is much greater number of particles escaping than shielded side B imparting a force in in B direction.

### CROSS REFERENCE TO RELATED APPLICATION

N/A

### FEDERALLY SPONSORED RESEARCH

NONE

### SEQUENCE LISTING

NONE

### BACKGROUND

This embodiment relates to a lifting or flying device using the energy from the radioactive decay of radioactive elements to accelerate an object. The force from the decay of an unobstructed side A of a flattened or curved radioactive emitting device has enough energy to push an object toward its opposite side B expelling particles or waves at relativistic speeds in its exhaust if side B is covered by a shield that prevents most of the radiation from escaping, FIG. 1, A view. It's important to note that any kind of radiation can be used for this embodiment with various results. Radioactive material Strontium 90 has 5.210 trillion decays of its nucleus per second per gram of mass, each decaying atom releases a Beta, β, particle, electron, with an average energy of 0.546 MeV per decay. The small microscopic explosions side A have enough energy per second from beta particles escaping if spread over a large surface area it forces the device towards shielded side B. As a result, it move's the decaying element and attached apparatus toward side B accelerating the object in said direction.

The decay rate of radiation varies depending on the atomic structure the radiating material. I will use radioactive Strontium 90 for the purpose of explaining how this embodiment would work, ⁹⁰Sr isotope. Strontium 90 is a radioactive isotope of Strontium produced by nuclear fission, with a half life of 28.8 years, it decays into Yttrium 90, ⁹⁰Y, with half-life of 64 hours, 2.7 days, then into a stable zirconium atom. The ⁹⁰Sr⁹⁰Y decay undergoes beta, β, decay, electron, e, with a decay energy of 0.546, 2.280 MeV respectfully distributed to an electron, an anti neutrino, and zirconium which is stable. Note that ⁹⁰SrY decay is almost a pure β particle source; the gamma photon emission from the decay of ⁹⁰Y is so infrequent that it can normally be ignored. ⁹⁰Sr has a specific activity of 5.210 TB, gram, g, ⁹⁰Y has a specific activity of 19,900 TBq g. One becquerel, Bq, is defined as the activity of a quantity of radioactive material in which one nucleus decays per second, as a result the specific activity of ⁹⁰Sr has 5,210,000,000,000 decays per second per gram with the average electron decay energy of 546,000 eV. One eV equals 1.609 times 10⁻¹⁹ Joules of energy as a result it will take 6.215 times10¹⁸ eV to equal 1 Joule. 5.210 TBq times 0.546 MeV equals 0.4557 Joules, both ⁹⁰Sr plus ⁹⁰Y having fission reactions every second 2 times 0.4557 Joules equals 0.91 Joules.

For the purpose of trying to not overstate the amount of energy available for this embodiment I used 0.91 Joules, also it's important to note that the amount of ⁹⁰Y fission per second per gram is much higher than ⁹⁰Sr's. The equivalent energy conversion to force is 1 Joule equals 1 Newton meter, Nm, a newton meter is a unit of torque to find a unit of force, newton, then we may do this by converting joules, to calories then to newtons. A newton is equal to 1 Kg of force acting on that object per second in the direction of its motion through a distance of 1 meter. As a result, the amount of energy released from 1 gram of ⁹⁰Sr⁹⁰Y per second is approximately 0.910 joules which less than half of the energy is directed towards the shield and the other less than half is escaping as Alpha or Beta particles. Due to the average momentum the β decay particle speed for ⁹⁰Sr is over 95.0 percent the speed of light, the average speed of ⁹⁰Y β decay particle is over 99.0 percent the speed of light. The ultimate speed of an object is dependent on its exhaust speed.

There are other ways to use radioactive thrust besides using 13 decay, another method may be using Alpha decay such as PU 238, ²³⁸PU, has a half life of 87 years and mostly releases Alpha particles only. Alpha particles would be a good candidate for Radiation Sails, although they carry a lot of energy Alpha particles can be stopped with a very thin sail material. Alpha particles can not go through a sheet of paper. Alpha particles are extremely ionizing, Alpha particles from radiation decay can be used to ionize gas in a ion drive providing more thrust, therefore not needing an auxiliary electrical power supply to carry with you. Using an Alpha particle Radiation Sail when lifted into space by conventional ways, chemical rocket, it could be used as a shuttle between planets. ²³⁸PU with a half life of 87. years could travel to our nearest stars or in between planets for 150 years or more without refueling.

It's Important to note that ⁹⁰Sr⁹⁰Y is hazardous material and must be treated as such. ⁹⁰Sr is very abundant at radioactive dump sites and is dangerous because it is absorbed into bones like calcium is if it gets in the digestive track though contaminated food. Caution must be used if it is exposed to the environment. If exposed to the radiating material at one atmosphere anything within a meter of ⁹⁰Sr or several meters of ⁹⁰Y will penetrate the skin causing cancer or radiation sickness. As a result, the main purpose would be to launch it into space then use it in space only as a shuttle between the earth and the solar system planets, planetoids, moons, comets and asteroids. It would be a good candidate to travel to our nearest stars systems to explore other planets, moon for life, and it's inhabitability.

U.S. Pat. No. 6,205,770B1 is one example of a chemical rockets that the speed is restricted by the fuel type used, maximum speed is approximately 58,000 KPH. Chemical Rockets are the only type of rockets ever used to lift an object into space, chemical rockets require a massive amount of fuel to obtain orbital speeds or to escapes earth's gravity. Nuclear thermal rockets theoretically have enough energy and thrust to lift an object into space, but the public acceptance of nuclear fuel rockets restricted its use at this time.

Patent number EP174844A1 shows a mass of nuclear fuel that is centrally place at a parabolic focal point emitting radiation onto a parabolic sail like material giving it thrust. The mass of radiation interferes with extracting all the available particles escaping its enclosed structure as thrust because the interference of the particles colliding with each other and the enclosed container. Therefore, it would be a lot less efficient than if you spread all the nuclear material onto the sail itself.

U.S. Pat. No. 9,180,985 B1 and U.S. Pat. No. 3,202,582A show Nuclear rockets embodiment that use the kinetic energy of a gas or liquid to produce thermal energy that increases the thrust out of rocket nozzle, its speed is limited by the thermal energy of the exhaust temperature that heats up the thermal protection system, TPS, of the rocket nozzle and can melt or vaporize all known TPS materials if it gets too hot as a result its maximum speed is less than approximately 150,000 KPH.

U.S. Pat. No. 9,068,562 B1 Boeing patent a nuclear laser fusion jet airplane engine. Its purpose was to suspend a deuterium and tritium in a projected part of the engine then focus a lasers or more onto the deuterium and tritium to cause it to fuse giving off a lot of heat and fast-moving neutron. The neutrons collide with a curved wall made from uranium 238, ²³⁸U, the ²³⁸U absorbs the neutron and fissions occurs. Some of the fission produce by capturing neutrons will releases gamma rays, which is hard to shield a thick block of lead is needed or a thick shield of other material. The process injects either Hydrogen or Helium gas as a coolant the coolant is heated up to a very high temperature from ²³⁸U fission decay particles and the nuclear fusion, the radioactive decay heating of the gas is shot out of the back of the nuclear airplane engine providing a huge amount of thrust. This process would have to have a nuclear modulator in front of the ²³⁸U to slow the fussionable fast moving neutrons down so the ²³⁸U can catch them to cause a fission reaction in the ²³⁸U. This would also work in space; however, you will still be limited by the amount of fuel you bring with you and the exhaust speed of the gas is much slower than an Alpha or Beta particle emitted in nuclear fission. No gas is needed in this embodiment I am filing except when boosting the Radioactive Decay Propulsion and Electrical Generating Device off out of a planet or moon gravity well.

U.S. Pat. No. 8,593,064B2 turns the thermal energy into electrical energy from nuclear fuel to supply electrical energy to an Ion drive, hall effect drive, or a VASIMR engine with varying results. These types of drives rely on fuel and a massive amount of solar or nuclear electrical energy to accelerate an object up to a maximum speed of 180,000 KMH. The amount of energy released by nuclear fission thermal apparatus or thermal electric to ultimately accelerate the device is miniscule compared to the amount of energy released in a nuclear fission reaction, as a result the energy used moves the device at a much slower speed and it adds more mass to the energy needed to accelerate the object.

### SUMMARY

This embodiment is an improved way to launch an object into space with the help of injecting gas into the debris field, once in space it is much more efficient way to explore our solar system and our nearby stars in a timely manner. No added mass is needed as propellant to accelerate it to its destination. It will vastly reduce the amount of time astronauts would spend in space exploring our solar system, therefor vastly reducing the amount of space radiation and bone loss they are subjected to on their journey in space. It can be used by space mining companies that may want to mine asteroids, comets, planets, planetary moons or minor planets.

Most nuclear fission type propulsion systems proposed in the past require huge cooling systems to prevent nuclear meltdown and massive radiation protective systems if humans are close to reactors. It mostly involved using the decay of nuclear material to heat a gas or liquid to extremely high temperature then either ejecting it out a nozzle to below relativistic speeds or turning it into a nuclear electric type propulsion system pushing an object forward through space. This embodiment, nuclear propulsion system, doesn't require any large cooling system or massive radiation shielding to protect the humans using it, no dangerous gamma-rays or fast and slow neutrons are emitted in the radioactive decay that's adds to the danger of traveling in space. With that being said, if it is used in space a protective shield may be used from space radiation depending on the duration of flight.

This embodiment speed is also only restricted by human or the machines endurance while traveling to speeds close to the speed of light. The exhaust of a propulsion device is the maximum speed and object can move. In this embodiment the exhaust speed of the β particles in the radioactive decay of the nuclear material varies up to 99 percent the speed of light. Just as humans were tested in the past speeding past the sound barrier, they will be tested at relativistic speeds traveling through the effects of time dilation.

Several different types of nuclear material can be used in place of the exampled nuclear material I proposed. Different types of radiation can be used as the propellant with varying degree of results. I proposed using Strontium 90 which decays into β particles only, it can easily be shielded, a miniscule amount of gamma particles is released in the decay of ⁹⁰Sr/⁹⁰Y. Some of the other types of radiation require a massive shielding apparatus to protect the occupants from high energy gamma particles, x-rays and slow/fast neutrons. ⁹⁰SR is abundant and can be extracted from radiation dump sites and spent fuel of nuclear power plants at a reasonable cost reducing the cost of the propulsion system. Some of the pure Alpha decay material like ²³⁸PU can be shielded by a 0.1 mm, 0.004 inch thick piece of paper 1.2 g per cm³ something denser than paper can be thinner like stainless steel which is 6.6 times denser than paper. As a result, ²³⁸Pu is a good candidate for a Radiation Sail that can be used as shuttle between planets for 150 years, half life is 87 years or sent to our nearest neighbor stars in a much more timelier manner than any propulsion device.

Another benefit of ⁹⁰Sr⁹⁰Y for a more rigid spacecraft than a solar sail, Beta particle can go though paper and require a denser material to stop it however the denser the material the thinner than the material needed to stop the radiation. ⁹⁰Sr⁹⁰Y and a pure ²³⁸Pu and some other beta emitter is that it doesn't need a massive cooling system to prevent a nuclear meltdown like other nuclear material because ⁹⁰Sr decays into ⁹⁰Y then into a stable non-radioactive zirconium atom. If in a large mass the maximum temperature is 500° C. which is over 270° C. lower than its melting point, if in a smaller thinner mass where most of the thermal energy can be radiated away the maximum temp would be much less than 500° C., however due to more extreme solar heating while in space from our sun a thin wall reflective cover may be needed to shield it from the sun. The cover would be thin enough to let over 90 percent of the alpha or beta particles to pass through it while it's close to the sun, see FIG. 6.

Accordingly, several objects and advantages of the embodiment are to provide a device to travel within our solar system and to our nearest stars in much more timely manner than current methods. The Nuclear Propulsion Device if large enough can be used to lift humans or payloads off earth into space if approval is given from the government where it resides. Note; some areas of the world have no laws that would govern its launch or landing.

### DRAWINGS

FIG. 1 is an artist view that describes how nuclear decay with trillions of microscopic explosions per gram can lift and propel an object in space

FIG. 2 shows a section of FIG. 1

FIG. 3 shows an artist drawing of a cubic centimeter sliced into 100 pieces that will cover 100 square centimeters surface area, 6

FIG. 4 is an artist drawing showing a lifting device using the recoil force from fission to move an device in the opposite direction as the exhaust particle

FIG. 5 Is an artist drawing showing how to control the force from the fission by opening or closing the exhaust side

FIG. 6 shows how a very thin solar radiation shield 7 can stop the sun from overheating the radioactive material

FIG. 7 is an artist drawing showing layers of cylindrical fissionable material heating up a gas 8 that is forced out of the rocket nozzle

FIG. 8 shows a Solar Sail that is propelled from the force of solar radiation, 9

FIG. 9 Shows a Radiation Sail that is propelled by 2, it doesn't need any other kind of propulsion or auxiliary electric power including the sun to explore our solar system and nearby stars

FIG. 10 Is an artist drawing from the shielded side 3 turning the kinetic energy from decaying particles 2 into thermal energy that then turns it into electrical energy by a Sirling engine

FIG. 11 is an artist drawing of a Thermal Electric Generator 11 that turns thermal energy into electrical energy from the shielded side 3

FIG. 12 is an artist drawing of trillions negative charged or positive charge particles 2 in one 1 gram of radioactive decaying matter exiting of a thin layer spread over 1 m² surface area

### DETAIL DESCRIPTION

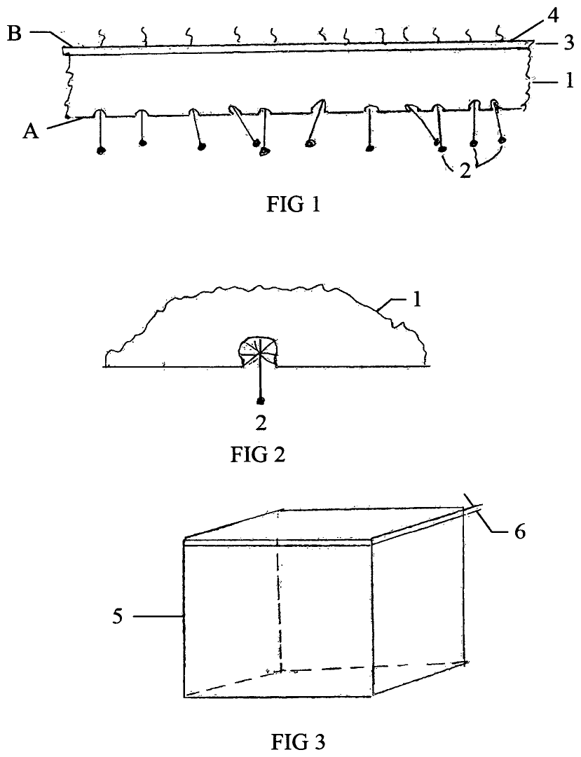

FIG. 1

In the use of nuclear fission power plants as much as 99.9 or more of the decaying matter releases its kinetic energy inside the nuclear material turning it into thermal energy, only the outside very thin surface releases decaying particles into the unobstructed space.

When I stated decaying particles for this explanation only, it refers to Alpha or Beta particles only. Fast neutrons, x-rays, gamma rays, can easily escape both sides of this embodiment.

If all that mass of radioactive particles were spread out in a thin enough layer approximately half of the particles go through A side and the other half of the particles go through B side then most of the decaying atoms are providing thrust on A side and the other decaying atoms is providing thermal energy from the kinetic energy that strikes shield 3 matter keeping them from escaping.

Note the thickness of the radioactive matter can be much more than a thin layer 1 to extract out more thermal energy that can be converted into electrical energy or used to heat the space probe from Side B. Side A is restricted to how many decaying particles escape directly underneath its top thin surface to provide thrust by its thickness and density over its surface area. The artist drawing explains how this embodiment would work using radioactive decay of atoms in matter 1, a thin radioactive coating surface of radioactive matter emits particles off side A. In FIG. 1 drawing the surface thickness 1 is thin enough that less than half of the escaping decay particle 2 escapes the nuclear fission matter on unobstructed side A into space, the other half of the particle in matter 1 is trapped between the thin shield 3 therefore is restricted from escaping side B turning its kinetic energy into thermal energy.

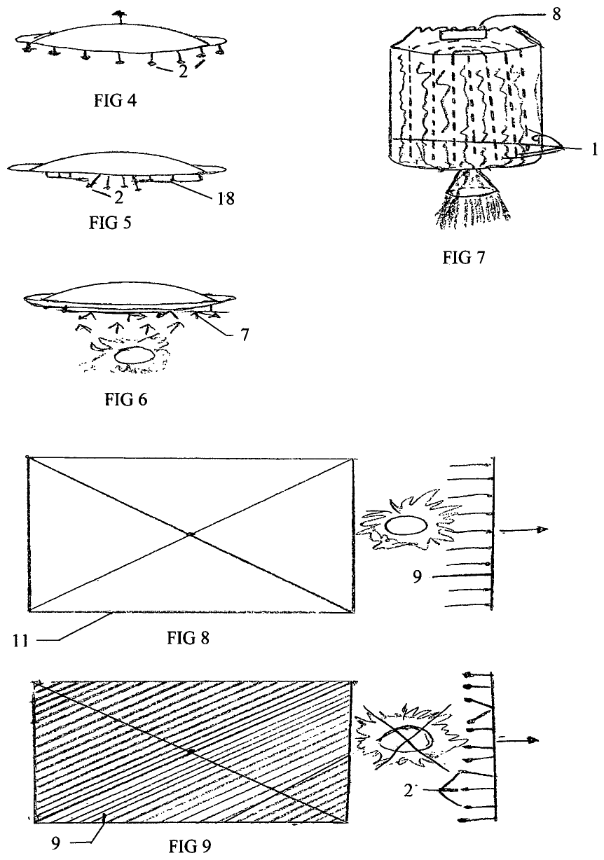

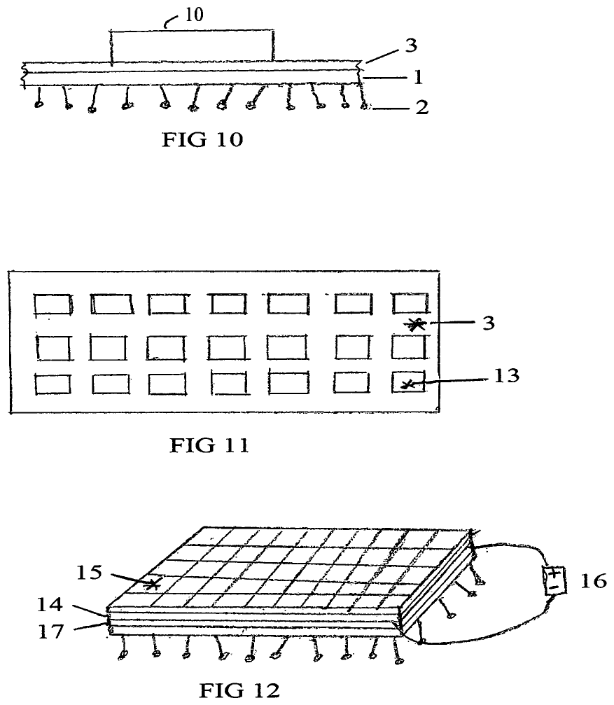

FIG. 2

Shows a section of FIG. 1 where particle 2 decays from mass 1 as stated in FI 1. Depending on the type of decay material some of the nuclear fission atoms such as ⁹⁰Y emits Beta particles with a 2.7 day half-life that decays into stable Zirconium 90, pure ⁹⁰Y has an immense amount of stored energy 19,900,000,000,000,000 or 19,900 trillion atoms decays per gram per second departing approximately 10,000 newtons of force from one side of a 32 square meter surface area like the solar Sail with an exhaust speed of 99 percent the speed of light, approximately 296,000 km/s.

FIG. 3

Shows an artist drawing of a cubic centimeter sliced into 100 pieces, 6, that will cover 100 square centimeters surface area, the mass and thickness is controlled by the density of the decaying material such that ⁹⁰Sr⁹⁰Y has a density of 2.64 grams per cubic centimeter.

FIG. 4

Is an artist drawing showing a lifting device using the recoil force from fission to move a device in the opposite direction as the exhaust particle from side A explosively escapes the surface, with a thin layer as much as trillions of particles per second per gram will exit the surface with a microscopic explosion speeding away at relativistic speeds.

FIG. 5

Is an artist drawing showing how to control the force from the fission by blocking or opening or closing the exhaust side doors. Simply by enclosing in the unshielded side a certain amount trapping the particles inside of the embodiment preventing the radiation from getting in the exhaust therefore reducing the force of the radioactive lifting device.

FIG. 6

Shows how a very thin solar radiation reflective shield 7 can stop the sun from overheating the radioactive material but allow escaping particles to go right through it. The reason to use the thin sun shield is to control the amount of solar radiation that hits side 1 keeping it from overheating in space when the unobstructed side faces the sun.

FIG. 7

Is an artist drawing showing layers of cylindrical fissionable material a short distance away from each other heating up a gas 8 FIG. 7 within an enclosed space that is forced out of the rocket nozzle. Alpha particles decay is highly ionizing, at 1 atmosphere can penetrate just a few centimeters of air, beta particles are ionizing too but not as much as Alpha particles, therefore injection a gas at a certain pressure, the radioactive walls can be very close to each other that radiates alpha particles ionizing and heating the exhaust gas allowing much more heat and the ionized gas, plasma, to escape. This method uses two types of forces as thrust in this embodiment that can be ejected giving it extra thrust like an ion drive before exiting the tank through the rocket engine nozzle increasing the thrust.

FIG. 8

Shows an artist drawing of a Solar Sail that is propelled from the force of solar radiation, 9 FIG. 8 on the sail material. A 32 square meter Solar Sail force from the Earths distance from the sun imparts a very small amount of thrust from solar radiation, approximately 0.00029 newtons of force on the sail.

FIG. 9

Shows an artist drawing of a Radiation Sail that is propelled by radiation particles 2, it doesn't need any other kind of propulsion, mass, or auxiliary electric power including the sun to explore our solar system and nearby stars. A PU238 Radiation Sail the same size as the Solar Sail force is approximately hundreds of times more force than a solar sail acting on the same size sail.

FIG. 10

Is an artist drawing from the shielded side 3 turning the kinetic energy from decaying particles 2 into thermal energy that then turns it into electrical energy by a Sirling Engine 10. At least half of the decay from the matter 1 is thermal heat that penetrates the shield 3, can be turned into electrical energy by a Siding Engine which has an efficiency of 31 percent.

FIG. 11

Is an artist drawing of a Thermal Electric Generator, TEG, 11 that turns thermal energy into electrical energy from the shielded side 3. A TEG will last for decades without being serviced has a maximum efficiency of 12 percent. One side of this embodiment provides thrust the other side provides energy for the probe or space travelers therefore not needing a large mass auxiliary power source.

FIG. 12

Is an artist drawing of trillions of negative charged or positive charge particles 2 in one 1 gram of a thin layer spread over 1 m² surface area of radioactive decaying matter from unobstructed side A providing thrust from negative charged or positive charge particles 2. On the opposite side B the shield 17 is a thin moderato that slows the particle speeds down to low UV speeds that strikes the florescence gas or film that trapped inside 14 giving off light. The light is captured by the solar cell that turns it into electricity. On the way through moderato 17 the particles interact with the easily ionized matter in 17 to give off a chain reaction of ionized particles that have energy within the medium visible light spectrum that also escapes 14. This adds to the other particles that went through 14 giving off even more light adding more photons that strikes trapped gas or film 14, increasing its photo electric effect turning it into electricity within solar cell 15. Conducting wires trapped between 17 and 14 removes the slower charge particles down enough for a anode and cathode that captures them creating a current charging a battery 16 adding to the solar cells electrical energy.

### REFERENCE NUMERALS

1 preferred radioactive decaying source material, such as ⁹⁰Sr⁹⁰Y or ²³⁸PU
2 escaping alpha, beta, gamma or neutrons particles
3 shield
4 radiant thermal energy
5 1 cubic centimeter
6 a thin layer
7 a thin reflective shield
8 a container of gas or liquid
9 solar photons
10 sirling engine
11 solar sail
12 radiation sail
13 thermal electric generator
14 fluorescent substances gas or film
15 solar cells
16 Battery to capture positive or negative charge particles
17 thin nuclear moderator that slows most of the alpha or beta particle momentum down before exiting

### OPERATIONS

A thin radioactive ⁹⁰SR⁹⁰Y coating is attached to a thin radiation shield the radiation is spread out in such a way as to extract the most beta particles out of the substance on one side while the other side is shielded to prevent β particles from escaping. As a result, it produces a force in one direction that will accelerate an object in space, its reaction would similar to what a solid rocket booster does to lift an object. One gram of ⁹⁰SR⁹⁰Y produces more than 0.91 joules of energy per gram, that energy is spread out to over 100 square centimeters, it is used to lift a device into space.

1) The nuclear matter beneath shield 3 adds thrust to the entire system by using a shield on side B side to stop alpha or beta particles from escaping while letting the continuous release of trillions of alpha or beta particles per second per gram on or near the surface of side A to lift the embodiment towards B.

2) The excess thermal energy FIG. 1 side B can be converted to electrical energy to power the instruments by converting some of the waisted thermal energy into electricity as shown in FIG. 10,11,12.

3) If using nuclear beta decaying particles a high voltage negative charged thin shield FIG. 13 18 for beta particles to deflect the β particles on the shielded side B towards the unopposed side will add extra force towards to this embodiment thrust. If using nuclear alpha decaying particles a high voltage positive charged thin shield FIG. 13 18 would deflect decaying alpha particles away from said shield adding more force to the thrust of this embodiment. Like amount of charged particles repel each other.

4) A Radiation Sail that is propelled by radiation particles 2, doesn't need any other kind of propulsion, mass, or auxiliary electric power including the sun to explore our solar system and nearby stars. A PU238 Radiation Sail the same size as the Solar Sail has more than 200 times more thrust than a solar sail acting on the same size sail. A lot of money has been spent on Solar Sail technology for such low amount of thrust, there is no chance of getting close to a fraction of the speed of light with a Soler Sail, one calculation will take it 1,000 years to reach one of our closest stars. A light sail does it in a much faster time. A massively costly Light Sail propelled with lasers to a Solar Sail like surface can get to a percent of the speed of light if it can maintain its focus on the sail, once the light sail get to a certain speed it has no way to slow down once it gets to its destination. A Radiation Sail doesn't need a massive auxiliary power source, the shielded side produces its own thermal and electric power. Radiation Sail can turn itself around to decelerate close to its destination to slow itself down before getting to its destination.

5)

6) If humans can survive time dilation past 20 percent the speed of light, then they can get to our closest star within 7 years with a Radiation Sail. It will take about 25 years at 20 percent the speed of light to get to our nearest stars.

7) Spreading a thin layer of radiation on the 32 square meter surface area adjacent to a protected shield, most of the alpha or beta particles FIG. 1, 2, on one side has enough energy to accelerate the object in space much faster than a Solar or Light Sail. Shield B restricts most of the Alpha or Beta particles from leaving the embodiment. For an example the VASIMR engine which must carry a massive amount of mass for its axillary power supply, top exhaust speed is 50 km/s with a VASIMR engine with 200 kilowatts of power that exerts only about 5 newtons of force. A ⁹⁰Sr⁹⁰Y Radiation Sail exhaust speed is up to 296,000 km/s about 99 percent of light. A pure ⁹⁰Y solar sail the size of the 32 meter Solar Sail thrust is about 10,000 newtons where the same size solar sails is 0.00029 newtons. Its important to note that the half life of ⁹⁰Y is 64 hours, it decays into stable zirconium.
